(19) United States
(12) Patent Application Publication
(10) Pub. No.: US 2026/0162951 A1
(43) Pub. Date: Jun. 11, 2026

(54) MASS SPECTROMETER

(71) Applicant: SHIMADZU CORPORATION, Kyoto-shi (JP)

(72) Inventors: Yohei TOJI, Kyoto-shi (JP); Yusuke SAKAGOSHI, Kyoto-shi (JP)

(21) Appl. No.: 19/404,247

(22) Filed: Dec. 1, 2025

(30) Foreign Application Priority Data
Dec. 9, 2024 (JP) 2024-214251

(51) Int. Cl. H01J 49/04; H01J 49/24

(52) U.S. Cl. CPC H01J 49/0468; H01J 49/0431; H01J 49/24

(57) ABSTRACT

An aspect of the present invention is an ion analysis apparatus comprising an interface unit (3) for introducing ions generated from a liquid sample in an ionization chamber (11) at substantially atmospheric pressure into a vacuum chamber (12), wherein the interface unit includes: a transport tube (30) through which ions flow; a first heating block (34) in which a heater (35) is embedded or provided in contact, the first heating block being attached to the ionization chamber side of a partition wall (9) that is part of an apparatus main body separating the ionization chamber and the vacuum chamber; a second heating block (33), separate from the first heating block, having a hole (33b) through which the transport tube is inserted; and a cover member (32) that is detachably attached to the ionization chamber side of the partition wall and covers the first and second heating blocks such that one end of the transport tube inserted through the hole of the second heating block protrudes, wherein when attached to the partition wall, the cover member presses the second heating block against the first heating block in a state where both heating blocks are in surface contact.

### TECHNICAL FIELD

The present invention relates to a mass spectrometer, and more particularly, to a mass spectrometer including an ion source that ionizes components in a liquid sample at substantially atmospheric pressure.

### BACKGROUND ART

In a mass spectrometer used for a liquid chromatograph-mass spectrometer (LC-MS), an ion source based on a so-called atmospheric pressure ionization method is used to ionize components in an eluate containing components eluted from a column of a liquid chromatograph (LC). As atmospheric pressure ionization methods, electrospray ionization (ESI), atmospheric pressure chemical ionization (APCI), and atmospheric pressure photoionization (APPI) are well known.

In a mass spectrometer equipped with such an atmospheric pressure ion source, in order to perform mass analysis on ions generated inside an ionization chamber, which is at a substantially atmospheric pressure atmosphere, it is necessary to transport the ions to a vacuum chamber. For example, in the mass spectrometers described in Patent Literature 1 and 2, the ionization chamber and the subsequent intermediate vacuum chamber are connected by a small-diameter tube called a desolvation line (DL), and ions generated in the ionization chamber are transported to the intermediate vacuum chamber through the desolvation line. Charged droplets in which the solvent has not sufficiently vaporized may directly enter the desolvation line, and in order to promote vaporization of the solvent from these droplets and achieve ionization, the desolvation line is heated to an appropriate temperature.

With prolonged use of the apparatus, the desolvation line may become clogged due to the solvent, mobile phase, and sample. Therefore, in a general mass spectrometer of this type, the desolvation line is structured to be relatively easily replaceable. For example, in the mass spectrometer disclosed in Non-Patent Literature 1, the desolvation line can be replaced by removing a plate-like component (heater flange) attached to the apparatus main body from the ionization chamber side to the front, and then pulling out the DL assembly, including the desolvation line, from the rear side of the heater flange.

A cartridge heater and a heating block, as disclosed in Patent Literature 2, are fixed to the heater flange, and the desolvation line is inserted through a hole formed in the heating block, thereby bringing the desolvation line and the heating block into contact. Furthermore, to supply heating power to the cartridge heater, the heater flange to which the cartridge heater is attached and the apparatus main body are connected by a pair of male and female connectors, such that when the heater flange is attached to the apparatus main body, the male and female parts of the connectors engage.

### CITATION LIST

### PATENT LITERATURE

[Patent Literature 1] Japanese Unexamined Patent Application Publication No. 2021-82497

[Patent Literature 2] International Publication No. 2023/073983

### NON-PATENT LITERATURE

[Non-Patent Literature 1] "LCMS (How to Replace DL)", [online], [searched on December 9, 2024], Shimadzu Corporation, Internet <URL: https://faq.an.shimadzu.co.jp/faq/show/3135?site_domain=default>

### SUMMARY OF INVENTION

### TECHNICAL PROBLEM

In recent years, as the applications of mass spectrometers have expanded, there has been a growing demand for a reduction in the installation space of the apparatus, and miniaturization of the mass spectrometer has become one of the challenges. In particular, due to the characteristics of its structure, a mass spectrometer has a relatively large depth, and a reduction in the depth dimension is desired. To reduce the depth dimension, shortening of the desolvation line is required, but with the conventional structure described above, it is difficult to secure space for mounting a cartridge heater on the heating block if an attempt is made to shorten the desolvation line. Furthermore, in the conventional structure described above, the insertion and removal of the connector are necessary when attaching and detaching the heater flange to and from the apparatus main body, which results in poor workability and a risk of damaging the connector.

The present invention has been made in view of the above problems, and its main object is to provide a mass spectrometer that can sufficiently secure space for mounting a cartridge heater while appropriately heating the desolvation line, even when the desolvation line is shortened. Another object of the present invention is to provide a mass spectrometer that can avoid the work of inserting and removing a connector for supplying power to the heater cartridge during tasks such as replacing the desolvation line.

### SOLUTION TO PROBLEM

An aspect of a mass spectrometer according to the present invention made to solve the above problem is a mass spectrometer including an interface unit for introducing ions generated from a liquid sample in an ionization chamber at substantially atmospheric pressure into a vacuum chamber, wherein the interface unit includes:

a transport tube through which ions flow,

a first heating block in which a heater is embedded or provided in contact, the first heating block being attached to the ionization chamber side of a partition wall that is part of an apparatus main body separating the ionization chamber and the vacuum chamber,

a second heating block, separate from the first heating block, having a hole through which the transport tube is inserted, and

a cover member that is detachably attached to the ionization chamber side of the partition wall and covers the second heating block and the first heating block such that one end of the transport tube inserted through the hole of the second heating block protrudes, wherein when attached to the partition wall, the cover member presses the second heating block against the first heating block in a state where the second heating block and the first heating block are in surface contact.

### ADVANTAGEOUS EFFECTS OF INVENTION

According to the above aspect of the mass spectrometer of the present invention, the transport tube can be appropriately heated via the first heating block and the second heating block while providing the heater for heating the transport tube (desolvation line) on the partition wall side, that is, the apparatus main body side. This makes it possible to sufficiently secure a space for mounting the cartridge heater between the apparatus main body and the cover member, even when the length of the transport tube is shortened, making it impossible to mount an elongated cartridge heater along the longitudinal direction of the transport tube. As a result, shortening of the transport tube can be achieved, and miniaturization of the apparatus can be realized. Furthermore, since the heater is attached to the apparatus main body side, the connection of wiring for supplying power to the heater can be made with a connector provided on the apparatus main body. This eliminates the need for inserting and removing the connector when attaching or detaching the cover member to replace the transport tube, thereby improving workability for tasks such as component replacement and preventing damage to the connector and wiring.

### BRIEF DESCRIPTION OF DRAWINGS

FIG. 1 is a configuration diagram of a main part of a mass spectrometer according to an embodiment of the present invention.

FIG. 2 is a schematic longitudinal cross-sectional view showing a schematic configuration of an interface unit in the mass spectrometer of the present embodiment.

FIG. 3 is a schematic longitudinal cross-sectional view illustrating the attachment and detachment of a cover member in the interface unit shown in FIG. 2.

FIG. 4 is a schematic longitudinal cross-sectional view illustrating the attachment and detachment of a desolvation line assembly to and from the cover member in the interface unit shown in FIG. 2.

### DESCRIPTION OF EMBODIMENTS

The mass spectrometer according to the present invention includes various types of mass spectrometers that analyze ions generated in an ion source at substantially atmospheric pressure by transporting them into a vacuum chamber. Hereinafter, an embodiment of the mass spectrometer according to the present invention will be described in detail with reference to the accompanying drawings.

### Overall Configuration and Operation of the Mass Spectrometer of the Present Embodiment

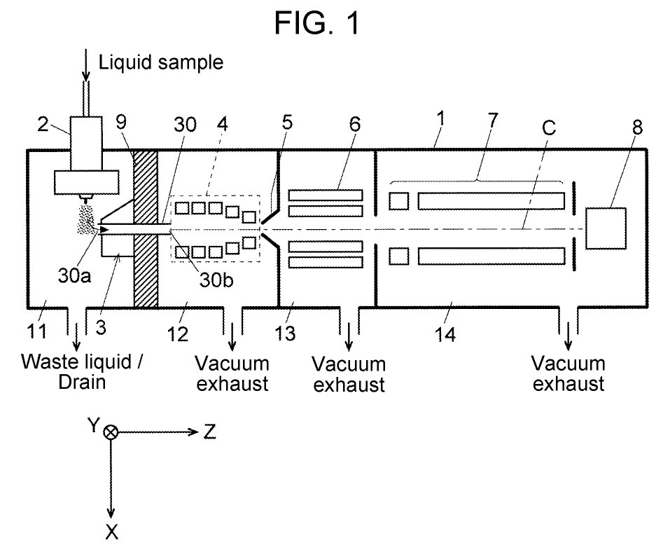

FIG. 1 is a schematic overall configuration diagram of the mass spectrometer of the present embodiment. This mass spectrometer is a so-called single-type quadrupole mass spectrometer. For convenience of explanation, three mutually orthogonal axes, X, Y, and Z, are defined in space in the figure.

As shown in FIG. 1, in the mass spectrometer of the present embodiment, the interior of a chamber 1 is partitioned into four sections: an ionization chamber 11, a first intermediate vacuum chamber 12, a second intermediate vacuum chamber 13, and an analysis chamber 14. The interior of the ionization chamber 11 is at a substantially atmospheric pressure atmosphere. The interior of the analysis chamber 14 is maintained at a high vacuum atmosphere by evacuation with a high-performance vacuum pump (not shown), and the interiors of the first intermediate vacuum chamber 12 and the second intermediate vacuum chamber 13 are also evacuated by respective vacuum pumps. This mass spectrometer has a multi-stage differential pumping system configuration in which the degree of vacuum increases sequentially from the ionization chamber 11 toward the analysis chamber 14.

An ESI probe 2 is disposed as an ion source in the ionization chamber 11, and a liquid sample containing sample components is sprayed from the ESI probe 2 as fine charged droplets in a direction generally along the X-axis. The charged droplets sprayed from the ESI probe 2 come into contact with the gas in the ionization chamber 11 and are atomized. The droplets are also atomized by the active evaporation of the solvent from the droplets. In this process, the sample components in the droplets acquire a charge and are ejected as ions.

The ionization chamber 11, which is at a substantially atmospheric pressure atmosphere, and the first intermediate vacuum chamber 12, which is at a vacuum atmosphere, are separated by a partition wall 9, and an interface unit 3 including a desolvation line 30, which functions as a transport tube for transporting ions, is provided on the partition wall 9. The central axis of an ion inlet 30a, which is the opening of the desolvation line 30 on the ionization chamber 11 side, extends substantially parallel to the Z-axis. Since there is a pressure difference between the two open ends of the desolvation line 30, a gas flow is formed from the ionization chamber 11 to the first intermediate vacuum chamber 12 through the desolvation line 30 due to this pressure difference. Ions derived from the sample components generated in the ionization chamber 11 are primarily carried by this gas flow, are drawn into the desolvation line 30 through the ion inlet 30a, and are discharged into the first intermediate vacuum chamber 12 together with the gas flow.

Ions entering the first intermediate vacuum chamber 12 are focused by the action of an electric field formed by a multipole ion guide 4 near a small hole at the apex of a substantially conical skimmer 5 that separates the first intermediate vacuum chamber 12 and the second intermediate vacuum chamber 13. The ions that pass through the small hole of the skimmer 5 are sent to the analysis chamber 14 via an ion guide 6 disposed in the second intermediate vacuum chamber 13. Inside the analysis chamber 14, a quadrupole mass filter 7 and a detector 8 are disposed. Ions are introduced along an ion optical axis C, which is parallel to the Z-axis, into the space along the long axis of the quadrupole mass filter 7. By the action of the electric field formed by the voltage applied to the quadrupole mass filter 7, only ions having a specific mass-to-charge ratio (m/z) pass through the quadrupole mass filter 7 and reach the detector 8. The detector 8 generates a detection signal corresponding to the amount of ions that have arrived and sends it to a data processing unit (not shown). In this mass spectrometer, the analysis sensitivity can be improved by sending a larger amount of ions to the quadrupole mass filter 7, that is, for analysis.

Although the ion source in this embodiment performs ionization by the ESI method, other ionization methods that perform ionization under a substantially atmospheric pressure atmosphere may be used, such as the APCI method, the APPI method, and furthermore, atmospheric pressure matrix-assisted laser desorption/ionization (AP-MALDI), probe electrospray ionization (PESI), desorption electrospray ionization (DESI), direct analysis in real time (DART), and the like.

### Configuration and Function of the Interface Unit

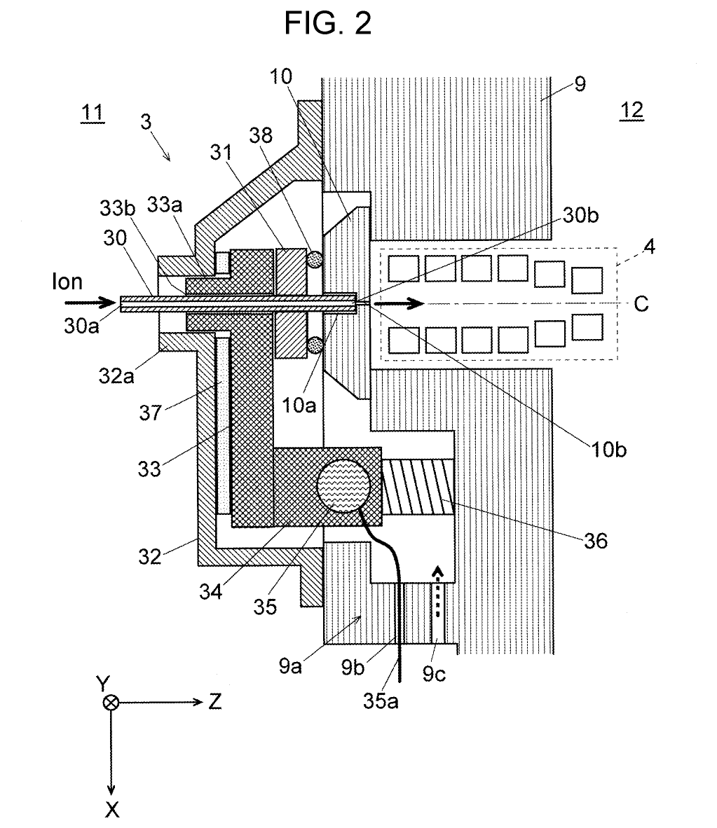

The configuration of the interface unit 3, which transports ions from the ionization chamber 11 side into the vacuum atmosphere, will be described in detail with reference to FIGS. 2 to 4.

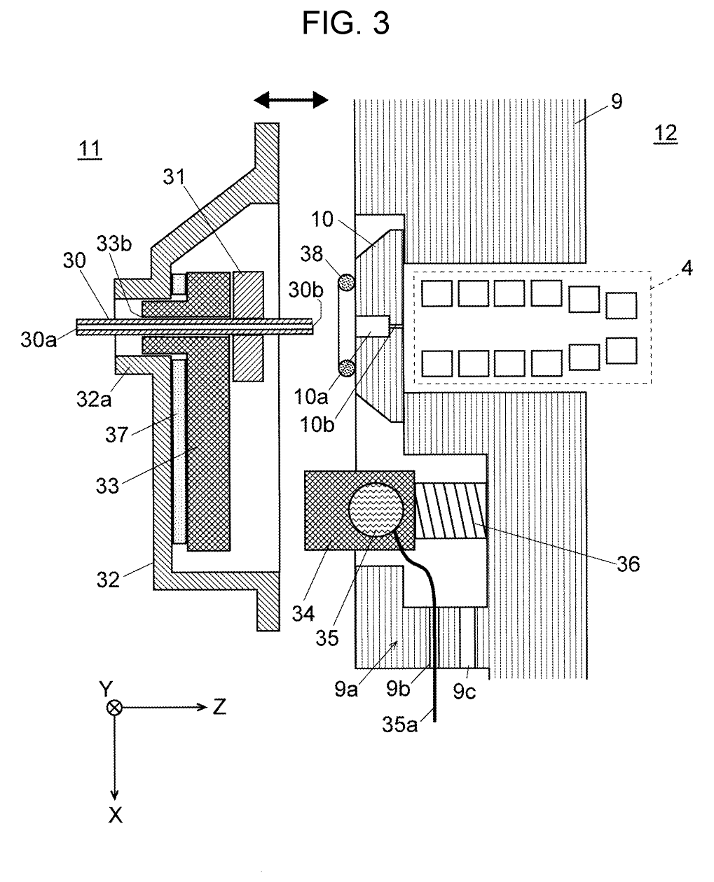

The partition wall 9 and a desolvation line holding part 10 fixed to the partition wall 9 are part of the apparatus main body that constitutes the chamber 1. A desolvation line 30, which is a thin tube made of a metal such as stainless steel and has a substantially cylindrical shape, and an annular desolvation line fixing flange 31 are integrated by welding or the like. The desolvation line holding part 10 is formed with a cylindrical desolvation line receiving hole 10a having an inner diameter slightly larger than the outer diameter of the desolvation line 30, and an ion ejection passage 10b of a predetermined diameter is provided through the bottom of the desolvation line receiving hole 10a. That is, as shown in FIG. 3, in a state where the desolvation line 30 is not mounted, the ionization chamber 11 and the first intermediate vacuum chamber 12 communicate through the desolvation line receiving hole 10a and the ion ejection passage 10b.

A first heating block 34 is attached to the inner surface of a substantially U-shaped (or substantially C-shaped) portion 9a of the partition wall 9 facing the ionization chamber 11 side, via an elastic member 36 that expands and contracts in the Z-axis direction. The elastic member 36 is typically a compression coil spring. The first heating block 34 (and a second heating block 33 described later) is made of a metal such as aluminum with good thermal conductivity. A cartridge heater 35, which is elongated in the Y-axis direction, is embedded in the first heating block 34, and the first heating block 34 is heated by this cartridge heater 35. A heating wiring 35a for supplying heating power to the cartridge heater 35 is inserted through a wiring inlet 9b formed in the substantially U-shaped portion 9a of the partition wall 9 and is connected to a connector mounted at a position not visible in FIG. 2. The heating wiring 35a is connected via this connector to wiring leading to a circuit unit arranged outside the chamber 1. Although not shown, wiring for applying a predetermined voltage to the desolvation line 30 is also inserted through the wiring inlet 9b, and its end is connected to the first heating block 34. Further, a gas inlet 9c is also formed in the substantially U-shaped portion 9a of the partition wall 9, and a gas pipe (not shown) is connected to the gas inlet 9c.

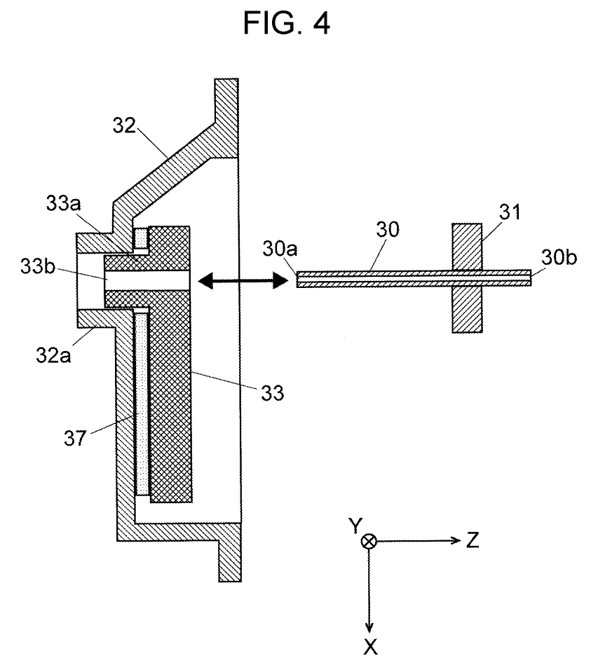

A substantially box-shaped heater cover 32 with one open side is detachably attached to the wall surface on the ionization chamber 11 side of the partition wall 9 by screws (not shown) or other mounting members. A second heating block 33 is attached to the back surface (the surface facing the partition wall 9) of the heater cover 32 via a plate-like heat insulating member 37. The second heating block 33 is made of the same material as the first heating block 34 and has a cylindrical portion 33a in which a hole 33b, through which the desolvation line 30 is inserted, is formed. As shown in FIG. 4, the desolvation line 30 is inserted through the hole 33b of the cylindrical portion 33a such that the desolvation line fixing flange 31 substantially abuts the second heating block 33. At this time, one end of the desolvation line 30, the tip of which becomes the ion inlet 30a, protrudes from the flange 32a of the heater cover 32 to the outside of the heater cover 32.

The other end of the desolvation line 30 (the end on the ion outlet 30b side) is inserted into the desolvation line receiving hole 10a. At this time, an annular seal member 38 is sandwiched between the desolvation line fixing flange 31 and the desolvation line holding part 10. The ion outlet 30b of the desolvation line 30 is substantially in contact with the bottom of the desolvation line receiving hole 10a, whereby the passage of the desolvation line 30 and the ion ejection passage 10b are connected. Gas containing ions and charged droplets that have passed through the passage of the desolvation line 30 passes through the ion ejection passage 10b and is ejected as a supersonic jet stream into the first intermediate vacuum chamber 12.

As shown in FIG. 2, in a state where the heater cover 32 is properly attached to the partition wall 9, the opposing surfaces of the second heating block 33 and the first heating block 34 are in close contact, and the second heating block 33 pushes the first heating block 34 in the positive Z-axis direction (to the right). Since the first heating block 34 is fixed to the partition wall 9 via the elastic member 36, when the first heating block 34 is pushed as described above, the elastic member 36 is compressed, and in response, the first heating block 34 comes into close contact with the second heating block 33 due to the biasing force with which the elastic member 36 pushes back. As a result, when the heater cover 32 is attached to the partition wall 9, good thermal conductivity between the first heating block 34 and the second heating block 33 is ensured.

Furthermore, the desolvation line fixing flange 31 pushes the seal member 38 to the right, and the seal member 38 is compressed to provide airtightness. This prevents gas from flowing from the space inside the heater cover 32 into the gap between the inner peripheral surface of the desolvation line receiving hole 10a and the outer peripheral surface of the desolvation line 30. The heater cover 32 covers the first heating block 34, the second heating block 33, and most of the desolvation line assembly (the portion other than the portion protruding from the flange 32a).

As shown in FIG. 4, when replacing the desolvation line assembly from the state where the heater cover 32 is attached to the partition wall 9, the user removes the heater cover 32 from the partition wall 9. As shown in FIG. 3, the heater cover 32 is removed with the second heating block 33 and the desolvation line assembly housed inside it. Furthermore, as shown in FIG. 4, the user removes only the desolvation line assembly by holding the desolvation line fixing flange 31 and pulling out the desolvation line 30 from the back side of the heater cover 32. When installing a new desolvation line assembly, the procedure can be performed in the reverse order of the removal described above.

The interface unit 3 with the structure described above functions as follows during analysis.

During analysis, the cartridge heater 35 becomes hot due to the heating current supplied through the heating wiring 35a. This heat is conducted sequentially to the first heating block 34, which is in contact with the cartridge heater 35, and to the second heating block 33, which is in contact with the first heating block 34, and heats the desolvation line 30 from the cylindrical portion 33a of the second heating block 33. The temperature of the desolvation line 30 is monitored by a temperature sensor (not shown), and the heating current supplied to the cartridge heater 35 is controlled so that its temperature is maintained at a target temperature. Further, since the first heating block 34, the second heating block, and the desolvation line 30 are electrically connected, when a predetermined voltage is applied to the first heating block 34 from wiring (not shown), the voltage is applied to the desolvation line 30 through the second heating block 33.

As described above, when ions derived from the sample and charged droplets in which the solvent (mobile phase) has not yet sufficiently vaporized, which are generated in the ionization chamber 11, are drawn into the desolvation line 30 from the ion inlet 30a by the gas flow, the vaporization of the solvent in the charged droplets is further promoted while passing through the desolvation line 30, which is maintained at a high temperature. This promotes the generation of ions derived from the sample. Then, the generated ions pass through the ion ejection passage 10b, are carried by the high-speed gas flow and discharged into the first intermediate vacuum chamber 12, and are focused by the action of the electric field formed by the ion guide 4.

In the interface unit 3, as indicated by the dashed arrow in FIG. 3, an inert gas such as N2 is supplied from a gas pipe (not shown) through the gas inlet 9c to the inside of the U-shaped portion 9a. This gas is heated by the first heating block 34 and the second heating block 33, passes through the narrow gap between the desolvation line fixing flange and the second heating block 33, and the narrow gap between the outer peripheral surface of the desolvation line 30 and the inner peripheral surface of the hole 33b of the second heating block 33, and is blown out from the inside of the flange 32a of the heater cover 32. That is, this heated gas flows so as to oppose the flow of gas drawn into the desolvation line 30 from within the ionization chamber 11. This can further promote the vaporization of the solvent in the charged droplets contained in the gas flow drawn into the desolvation line 30.

### Effects of the Interface Unit

The effects of configuring the interface unit 3 as described above are listed below.

(1) In the conventional mass spectrometer described in Patent Literature 2, the cartridge heater and the heating block were arranged on the heater flange so as to extend along the longitudinal direction of the desolvation line. Therefore, the size of the interface unit in the Z-axis direction was large in order to secure space for arranging the cartridge heater and the heating block. In contrast, in the mass spectrometer of the present embodiment, the heating block is separated into the first heating block 34 and the second heating block 33, and the cartridge heater 35 is arranged on the apparatus main body (partition wall 9) side. Therefore, even if the size of the interface unit 3 in the Z-axis direction is reduced, a sufficient space for arranging the cartridge heater 35 can be secured. This makes it possible to shorten the desolvation line 30, which is advantageous for miniaturizing the entire apparatus.

(2) Since the cartridge heater 35 has a structure that remains on the apparatus main body side, the work of inserting and removing the connector that relays the heating wiring 35a for supplying power to the cartridge heater 35 is unnecessary when removing the desolvation line assembly from the interface unit 3 or, conversely, attaching it to the interface unit 3. This simplifies the work for the user, such as replacing the desolvation line assembly, and also avoids damage to the wiring and connectors that tends to occur during the connector insertion and removal work.

(3) The connector that relays the heating wiring 35a for supplying power to the cartridge heater 35 can be placed at a position sufficiently far from particularly hot parts such as the cartridge heater 35 and the heating blocks 33, 34. This makes it possible to set the temperature of the desolvation line 30 higher than in the conventional case, even when a resin with relatively low heat resistance is used for the connector, and to further promote the vaporization of the solvent in the charged droplets to improve the ion generation efficiency.

### Modifications

The shape, arrangement, size, etc., of each member in the interface unit 3 of the mass spectrometer of the above embodiment can be changed as appropriate. For example, in the above configuration, the second heating block 33 was attached to the heater cover 32 via the heat insulating member 37, but the second heating block 33 may not be fixed to the heater cover 32, and the second heating block 33 may be positioned by inserting the desolvation line 30 into the hole formed in the second heating block 33.

Further, although the above embodiment is an example in which the present invention is applied to a single-type quadrupole mass spectrometer, the present invention can also be applied to other types of mass spectrometers that use the various atmospheric pressure ionization methods as described above and analyze ions generated in the ion source by transporting them into a vacuum atmosphere, specifically, a triple quadrupole mass spectrometer, a quadrupole-time-of-flight mass spectrometer, and the like.

Furthermore, the above embodiments and modifications are merely examples of the present invention, and it is clear that further modifications, additions, and corrections may be made as appropriate within the spirit of the present invention and are included in the scope of the patent claims of the present application.

### Various Aspects

Those skilled in the art will understand that the exemplary embodiments described above are specific examples of the following aspects.

(First Aspect) An aspect of a mass spectrometer according to the present invention is an ion analysis apparatus including an interface unit for introducing ions generated from a liquid sample in an ionization chamber (11) at substantially atmospheric pressure into a vacuum chamber, wherein the interface unit includes:

a transport tube through which ions flow,

a first heating block in which a heater is embedded or provided in contact, the first heating

block being attached to the ionization chamber side of a partition wall that is part of an apparatus main body separating the ionization chamber and the vacuum chamber,

a second heating block, separate from the first heating block, having a hole through which the transport tube is inserted, and

a cover member that is detachably attached to the ionization chamber side of the partition wall and covers the second heating block and the first heating block such that one end of the transport tube inserted through the hole of the second heating block protrudes, wherein when attached to the partition wall, the cover member presses the second heating block against the first heating block in a state where the second heating block and the first heating block are in surface contact.

According to the mass spectrometer of the first aspect, the transport tube can be appropriately heated via the first heating block and the second heating block while providing the heater for heating the transport tube on the partition wall side, that is, the apparatus main body side. This makes it possible to sufficiently secure a space for mounting the cartridge heater between the apparatus main body and the cover member, even when the length of the transport tube is shortened, making it impossible to mount an elongated cartridge heater along the longitudinal direction of the transport tube. As a result, shortening of the transport tube can be achieved, and miniaturization of the apparatus can be realized. Furthermore, since the heater is attached to the apparatus main body side, the connection of wiring for supplying power to the heater can be made with a connector provided on the apparatus main body. This eliminates the need for inserting and removing the connector when attaching or detaching the cover member to replace the transport tube, thereby improving workability for tasks such as component replacement and preventing damage to the connector and wiring.

(Second Aspect) In the mass spectrometer according to the first aspect, the interface unit may further include a biasing part that biases at least one of the heating blocks in a direction that strengthens the contact between the first heating block and the second heating block when the cover member is mounted on the partition wall.

Here, as the biasing part, for example, an elastic member such as a compression coil spring can be used. According to the mass spectrometer of the second aspect, since the adhesion between the first heating block, which directly receives heat from the heater, and the second heating block, which transmits heat to the desolvation line, is improved, the thermal conductivity can be enhanced, and the desolvation line can be heated well.

(Third Aspect) In the mass spectrometer according to the second aspect, the first heating block may be attached to the partition wall via the biasing part, and the second heating block may be attached to the cover member.

In the mass spectrometer according to the third aspect, when the cover member is attached to the partition wall, the second heating block attached to the cover member pushes the first heating block, and the biasing part pushes back the first heating block, thereby improving the adhesion between the first heating block and the second heating block. This makes it possible to enhance the adhesion between the first heating block and the second heating block by attaching the cover member to the partition wall, and to heat the desolvation line well.

(Fourth Aspect) In the mass spectrometer according to any one of the first to third aspects, the configuration may be such that when the cover member is removed from the partition wall, the desolvation tube is separated from the partition wall together with the cover member while being inserted through the second heating block.

According to the mass spectrometer of the fourth aspect, the desolvation line can be easily removed from the interface unit by removing the cover member and pulling out the desolvation line from the second heating block attached to the cover member. This can improve the workability of replacing the desolvation line.

(Fifth Aspect) In the mass spectrometer according to any one of the first to fourth aspects, the heater may be an elongated cartridge heater and may be arranged so as to extend in a direction orthogonal to the extending direction of the solvent tube.

According to the mass spectrometer of the fifth aspect, the size of the interface unit in the transport direction, for transporting ions from the ionization chamber to the vacuum chamber, can be reduced while sufficiently heating the desolvation line. This can contribute to the miniaturization of the apparatus.

### REFERENCE SIGNS LIST

1... Chamber

11... Ionization chamber

12... First intermediate vacuum chamber

13... Second intermediate vacuum chamber

14... Analysis chamber

2... ESI probe

3... Interface unit

30... Desolvation line

30a... Ion inlet

30b... Ion outlet

31... Desolvation line flange

32... Heater cover

32a... Flange

33... Second heating block

33a... Cylindrical portion

33b... Hole

34... First heating block

35... Cartridge heater

35a... Heating wiring

36... Elastic member

37... Heat insulating part

38... Seal member

4... Ion guide

5... Skimmer

6... Ion guide

7... Quadrupole mass filter

8... Detector

9... Partition wall

9a... Substantially U-shaped portion

9b... Wiring inlet

9c... Gas inlet

10... Desolvation line holding part

10a... Desolvation line receiving hole

10b... Ion ejection passage

1. A mass spectrometer, comprising an interface unit for introducing ions generated from a liquid sample in an ionization chamber at substantially atmospheric pressure into a vacuum chamber,
wherein the interface unit comprises:
a transport tube through which ions flow;
a first heating block in which a heater is embedded or provided in contact, the first heating block being attached to the ionization chamber side of a partition wall that is part of an apparatus main body separating the ionization chamber and the vacuum chamber;
a second heating block, separate from the first heating block, having a hole through which the transport tube is inserted; and
a cover member that is detachably attached to the ionization chamber side of the partition wall and covers the second heating block and the first heating block such that one end of the transport tube inserted through the hole of the second heating block protrudes, wherein when attached to the partition wall, the cover member presses the second heating block against the first heating block in a state where the second heating block and the first heating block are in surface contact.

2. The mass spectrometer according to claim 1, wherein the interface unit further comprises a biasing part that biases at least one of the heating blocks in a direction that strengthens the contact between the first heating block and the second heating block when the cover member is mounted on the partition wall.

3. The mass spectrometer according to claim 2, wherein the first heating block is attached to the partition wall via the biasing part, and the second heating block is attached to the cover member.

4. The mass spectrometer according to claim 1, wherein when the cover member is removed from the partition wall, the desolvation tube is configured to be separated from the partition wall together with the cover member while being inserted through the second heating block.

5. The mass spectrometer according to claim 1, wherein the heater is an elongated cartridge heater and is arranged to extend in a direction orthogonal to an extending direction of the solvent tube.
